(19) United States
(12) Patent Application Publication
(10) Pub. No.: US 2009/0144067 A1
(43) Pub. Date: Jun. 4, 2009

(54) Method and Apparatus for Controlling Access to Liability Exposure Data

(75) Inventor: Alan Harrison Keefer, San Mateo, CA (US)

Correspondence Address: FITCH EVEN TABIN AND FLANNERY, 120 SOUTH LASALLE STREET, SUITE 1600, CHICAGO, IL, 60603-3406, US

(73) Assignee: GUIDEWIRE SOFTWARE, INC., San Mateo, CA (US)

(21) Appl. No.: 11/948,733

(22) Filed: Nov. 30, 2007

(51) Int. Cl. G06Q 99/00

(52) U.S. Cl. 705/1

(57) ABSTRACT

A computer-based processing system for use in controlling access to liability exposure data contains input received from an end user. The end user declares a plurality of exposure security levels that are associated with particular liability exposure data. A permission is declared for a user and the permission is mapped to the exposure security level. Upon an attempt to access the particular liability exposure data, the system then automatically verifies whether the user attempting to access the data has the permission required to access the exposure security level correlating to the particular liability exposure data.

### TECHNICAL FIELD

This invention relates generally to insurance claim handling and more particularly to management of liability exposure data related to insurance claims.

### BACKGROUND

Automated computer-based processing systems, including those used to manage insurance claims, require the processing of a substantial amount of data, some of which may be of a sensitive nature. Insurance claims are commonly divided into pieces known as “exposures” and claims typically have liability exposure data associated therewith. As used herein the term exposure describes a covered loss or a possible need to pay coupled with a claimant. Since a single incident for which an insurer is liable may yield multiple exposures, liability exposure data for an insurance claim may include information pertaining to a number of individuals and properties.

Liability exposure data is critical to the processing of insurance claims, however, the process of handling the claims necessarily involves many different pairs of eyes over a period of time and sensitive materials may require some level of protection from general accessibility. Due to the large amount of data managed by insurers, accessibility of data needs to be managed automatically or at least conveniently to ensure confidentiality of sensitive materials. In addition, different system users will need to be able to accomplish different tasks. For example, certain users will need to be able to read and write claims but not edit previously entered data. In addition, certain users may only be able to perform tasks on a certain type of exposure. For example, if the insurance claim includes a bodily injury exposure and a property damage exposure, it may be desirable to have a given user only allowed to read the property damage exposure data and not the bodily injury exposure data.

Access to sensitive information may be limited by dividing users into those that either can or cannot access the data. By one approach this may be accomplished by using a password to protect data. In such systems if you have the password, and thus access, you have complete access to read, write, edit, and perform functions such as approving payments. In addition to giving users the ability to do things for which they lack the authority, such a system gives rise to other security, legal, and confidentiality issues. A simple access-permitted or access-denied system does not support a more flexible subtle or nuanced approach that might provide for denying or granting access to certain features, users, data or the like under certain conditions or situations.

### BRIEF DESCRIPTION OF THE DRAWINGS

The above needs are at least partially met through provision of the method and apparatus for controlling access to liability exposure data described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises an illustrative screen shot as configured in accordance with various embodiments of the invention;

FIG. 4 comprises an illustrative screen shot as configured in accordance with various embodiments of the invention;

FIG. 5 comprises an illustrative screen shot as configured in accordance with various embodiments of the invention;

FIG. 6 comprises an illustrative screen shot as configured in accordance with various embodiments of the invention;

FIG. 7 comprises an illustrative screen shot as configured in accordance with various embodiments of the invention; and

FIG. 8 comprises an illustrative screen shot as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments a computer-based processing system for use in controlling access to liability exposure data is provided, with the system receiving input from an end user. The end user declares a plurality of exposure security levels that are to be associated with particular liability exposure data. A permission is declared and the permission is mapped to the exposure security level. The mapped permission is then assigned to any users who should be able to access exposures at the declared security level. Upon an attempt to access the particular liability exposure data, the system then automatically verifies whether the user attempting to access the data has the permission required to access the exposure security level correlating to the particular liability exposure data.

By one approach, one of the permissions comprises a fundamental access right to access liability exposure data at the exposure security level. Other of the permissions may comprise supplemental access rights that correspond to specific types of permissions that may be accorded to the user in addition to the fundamental access right. Thus, a plurality of permissions may be associated with one user. Examples of such permissions include, but are not limited to, permission to approve, assign, edit, make mandatory, view, delete, close, reopen, open, and validate portions or all of the particular liability exposure data.

So configured, these teachings support controlling access to liability exposure data by conditioning access upon the level of security assigned to a type of exposure and whether the permissions required for the type of access sought has been granted to the user. By controlling access to data at the exposure level, a considerable amount of potentially confidential exposure data may be efficiently, possibly automatically, protected from unlimited access. Further, varying types of access may be granted to users by having a plurality of permissions correlating to specific types of access.

Those skilled in the art will appreciate that a single claim file that is comprised of several exposures, which may or may not be adjudicated and paid separately but which contain information of varying sensitivity, will likely have different restrictions on different subsets of the exposures in the claim file. Such a system as is herein disclosed provides flexibility while effectively and efficiently guarding information from unnecessary disclosure to those who do not require such access to such information. A configurable system allows insurers who are subject to regulations and policies governing access to information to implement changes to information access at the exposure level.

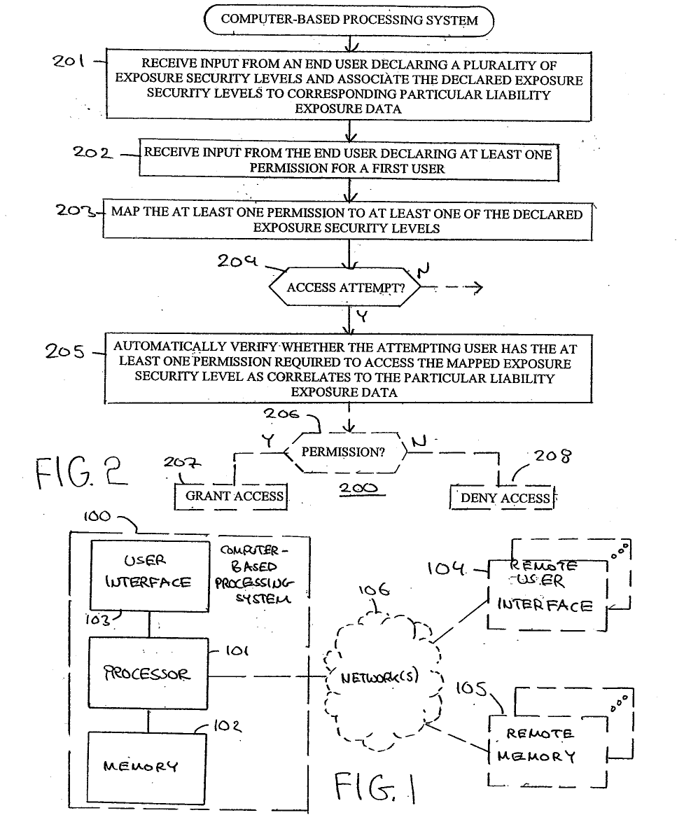

These and other benefits may become clearer upon making a thorough review and study of the following detailed description. Referring now to the drawings, and in particular to FIG. 1, these teaching are generally intended for application employed in conjunction with a computer-based processing system 100 for use in controlling access to liability exposure data that contains input from an end user. The computer-based processing system 100 may comprise, at least in part, a processor 101 that operably couples with a memory 102 and a user interface 103. By one approach, the user interface 103 can comprise a browser-based interface or may be implemented via a structured text file such as extensible markup language (XML). The processor 101, as shown, can also optionally couple to a remote user interface 104 or a remote memory 105 via a network 106.

The memory 102 can serve to store, for example, input received from the user interface 103. Such input received may include, for example, declared exposure security levels, a list of permissions, and the permissions granted to a particular user. In one embodiment, the declared exposure security levels, list of permissions, and process functions are customer editable such that it is possible to edit the levels, lists, mappings, and the like at any time after their creation. In addition, the memory 102 may serve to store liability exposure data which may include the information in the exposure along with notes, associated activities, or documents associated or linked thereto. Like the exposure itself, access to the associated documents, activities, or notes should be similarly restricted such that access is conditioned on the user having the permission to access data correlating to that particular exposure security level.

By one approach, the data discussed herein may be expressed using a relational data paradigm. For example, the exposure itself may comprise a whole tree of data and the exposure table may be the root of the tree. Further, in such a paradigm the exposure security level may be stored on the exposure table in a specified column. Such an exposure security level may be automatically assigned by a set of rules or may be manually assigned when the exposure is created. In one embodiment, either assignment method provides for editing sometime after the exposure is created.

The processor 101 can comprise a hard-wired dedicated purpose platform or can comprise a partially or wholly programmable platform. Such architectural options are well known in the art and require no further elaboration here. The processor 101 can be configured and arranged (via, for example, suitable programming as will be well understood by those skilled in the art) to effect one or more steps, actions, and functionality described herein.

Referring now to FIG. 2, an illustrative corresponding process 200 facilitates receiving 201 input data from an end user declaring a plurality of exposure security levels and associating those declared security levels to particular liability data. The exposure security level that is associated with particular liability data can be based upon the confidential nature of the data stored therein. The processor 101 is configured to map, tag, or otherwise associate one of the declared exposure security levels to particular liability data based upon input received from the end user.

By one approach, the exposure security levels generally correlate to an exposure type and, thus, the description given the declared exposure security levels may reflect the type of exposure. For example, declared exposure security levels may include a “bodily injury” exposure level, an “employee involved” exposure level, and a “celebrity involved” exposure level. By another approach, declared exposure security levels may be less descriptive or chosen to reflect a different security requirement. By one approach, exposure security levels may include, for example, level 1, level 2, level 3, and so forth.

In addition, the exposure security levels generally correspond to a few different categories of confidential information. One such category may be public information such that all of the users of the computer-based processing system may gain access. In addition, some information may be of a sensitive nature such that only those users with certain permissions may access, while other data may be of an extremely sensitive nature also requiring particular additional permissions.

As mentioned, associating the exposure security level with liability exposure data may occur manually or automatically through a set of programmed rules. In one embodiment, the exposure liability data may have a number of exposure security levels associated therewith. For example, if an employee is a claimant with a bodily injury claim, then both exposure security levels (“employee involved” and “bodily injury”) may be associated with the exposure security data. The association of the exposure liability data with exposure security levels may also be edited after the creation of the exposure whether manual or automatic. Such automatic association of the exposure security level and thus automatic restriction of access to the data may be desirable for information of an extremely sensitive nature so as to avoid inadvertent availability of extremely confidential information.

Continuing with FIG. 2, after receiving 202 input from the end user declaring the permission(s) to be given a particular user, the processor 101 maps 203, tags, or otherwise associates one of the declared exposure security levels to a permission. By one approach, the particular permission granted to the user may give the user complete or full access to manipulate the exposure itself and the exposure liability data contained therein. By another approach, the permissions may grant different types of access and may be granted for a variety of purposes. Such a paradigm parses or divides out the permissions that may be granted and results in a highly configurable system that may accommodate nuances in an end user's business practice.

As a preliminary note, in one embodiment, it is anticipated that a number of permissions will often be granted to one particular user. By one approach, one of the permissions comprises a fundamental access right. This fundamental access right may give the user the right to generally access the exposure. Such general access may or may not permit the user to view the entire exposure. In one embodiment, the fundamental access right permits the user to access certain general exposure information or to confirm that such an exposure exists without permitting access to view the entirety of the exposure. Additional permissions such as supplemental access rights may be required for the user to further access the exposure. The supplemental access rights may correspond to specific types of permissions that may be accorded to the user in addition to the fundamental access right. For example, supplemental access rights may include, but are not limited to, the permission to approve, assign, edit, make mandatory, view, delete, close, open, reopen, and validate portions or all of the exposure liability data. Thus, since a user may have a plurality of access rights, a particular user may be granted, for example, the fundamental access right plus supplemental access rights including the right to view, open, and close exposures.

By one approach, the exposure liability data may be comprised of a number of components such as the exposure itself, an activity such as a payment, a number of related documents, and possibly a note or comment section, to note but a few possible components. In one embodiment, other permissions in addition to the fundamental access right may be granted and such supplemental access rights can be granted to particular components of the exposure. For example, for an activity, a user may have the permission to view, edit, assign, approve, and make mandatory the activity in addition to the fundamental right to access the exposure with which the activity correlates. With respect to documents related to an exposure, a user may be able to view, delete, and edit such a document or the link to such a document in addition to fundamentally access that exposure. For the exposure itself, in addition to having the permission that comprises the fundamental access right, a user may be granted supplemental access rights giving the user the permission to be able to view, validate, reopen, edit, close, and assign the exposure. With respect to a note or comment section, supplemental access rights may include the permission to delete, edit, and view. By dividing the exposure into components and creating exposure-parsed access rights, the system 100 becomes increasingly configurable and readily scales to meet the needs of essentially any potential application setting.

Components of the exposure may be linked to the exposure in a variety of ways. In a relational database embodiment, a foreign key would be defined to link the component to the exposure. When an attempt is made to access the component, the link would be traversed to find the relevant exposure, and the permission check would be done as described in order to determine whether the user has access to the exposure and therefore to the linked component. Note that the traversal may be done across multiple levels, for example to associate a note to a document, with the document being in turn associated to the exposure. Following foreign key associations in this way is well understood by those skilled in relational database technology.

By way of an illustrative example, one user may have the permission to fundamentally access exposures within certain exposure security levels and further to view and edit the exposures themselves but not to edit the activities associated with the exposure. A senior claims adjuster, however, may have the permission to fundamentally access exposures (including corresponding activities, documents, and notes) having a certain exposure security level and then further to approve, assign, view, close, reopen, open, and validate portions of the exposure liability data.

In one embodiment, each user may not have to be assigned a list of permissions if instead the system is configured to accommodate the users being assigned a role or roles such that one particular role, such as a senior claims adjuster, correlates to a set of permissions that may be assigned to a user. Thus, when a user is assigned a role the corresponding permission set correlated to that role will be automatically granted to the user unless the end user or a system administrator seeks to modify the list of permissions.

As shown in FIG. 2, upon an attempt 204 to access exposure liability data, the processor 101 automatically verifies 205 whether the attempting user has the particular permission that is required to access the exposure security level that correlates to the particular liability data that the user is attempting to access. During the process 200, if an access attempt 204 is not made, then the process continues on without verifying whether the user has certain needed permissions. After a user has attempted access 204 and the processor has automatically verified 205 if the permission has been granted to the attempting user, then access may be granted 207 to an attempting user if the user has the particular permission 206 required to access the exposure security level that was associated with the particular liability exposure data desired. Alternatively, if the user does not have the particular permission 206 required to access exposure liability data correlating to a particular exposure security level, then access is denied 208.

As previously discussed, by one approach the user must have the fundamental access right to access the exposure in addition to the particular permission required to access the exposure in the manner being attempted by the user. Thus, for example, when the user is attempting 204 to edit a particular exposure such as an exposure within level 2, the processor 101 will verify whether the attempting user has the fundamental right to access exposure security level 2 exposures. In addition, if the user also has the supplemental access right correlating to the permission to edit exposures, then access to edit that exposure will be granted to the user as requested.

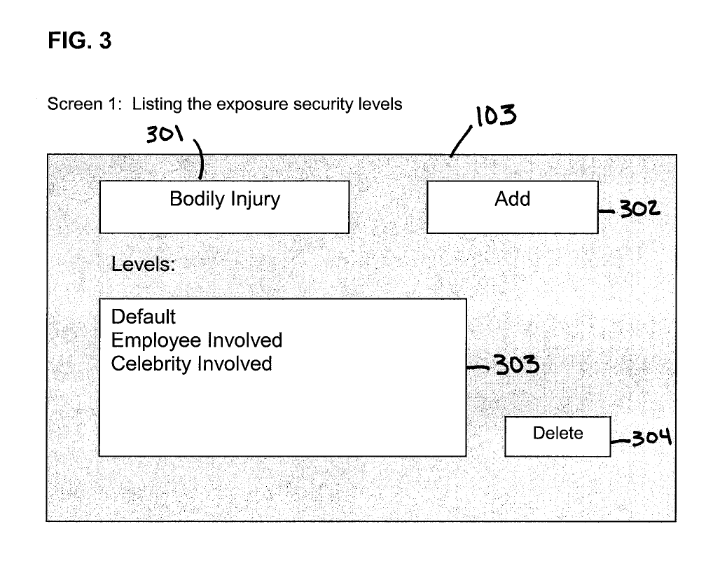

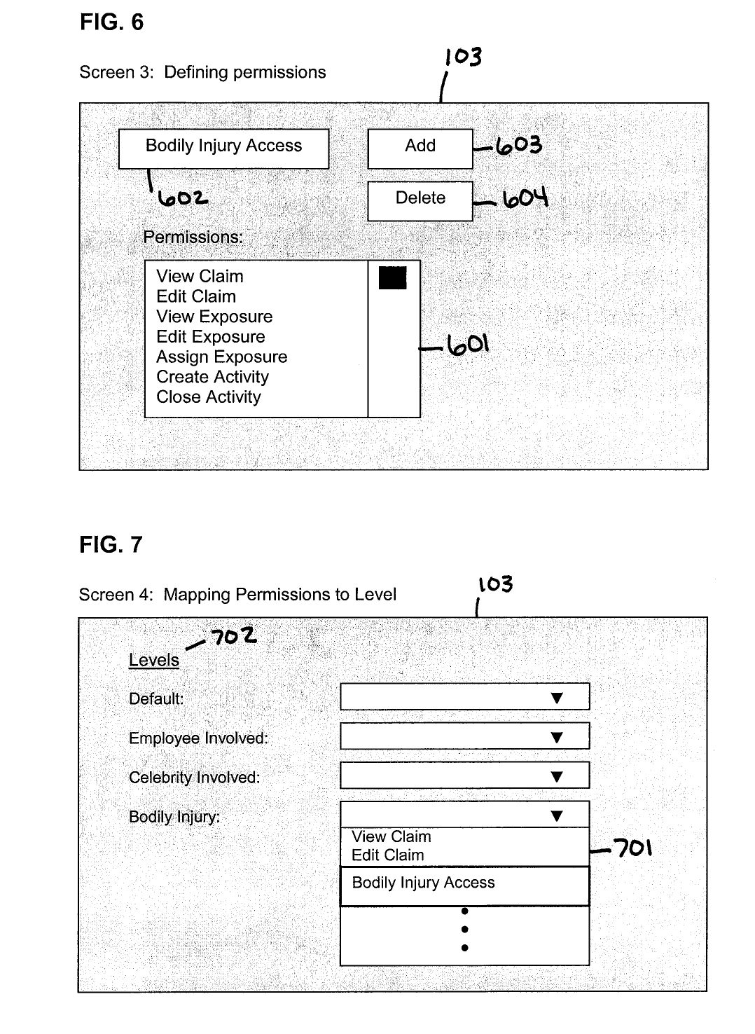

Turning now to FIG. 3, an illustrative screenshot of the user interface 103 shows a listing of a number of exposure security levels 303, which in this example include a “default” level, an “employee involved” level, and a “celebrity involved” level. The user interface 103 as described herein is a display as is typically used to convey or receive information. FIG. 3 demonstrates how exposure security levels may be declared or added by the end user. In this illustration, an end user has inserted a fourth exposure security level, “bodily injury,” into a prompt 301 such that when the add button 302 is clicked, another level labeled “bodily injury” will be added to the exposure security levels displayed 303, which in FIG. 3 include “default,” “employee involved,” and “celebrity involved.” If an end user wishes to remove an exposure security level, the level can be highlighted in the list of levels 303 and removed by clicking on the delete button 304. A list of permissions may be declared in much the same manner. For example, the interface 103 may include a configuration similar to FIG. 6 such that permissions, such as “view claim,” “edit claim,” and “view exposure,” are listed and additional permissions may be added by the end user. While the system is highly configurable, it should be noted that a number of standard exposure security levels and permissions may be predefined such that the user may alter a default or standard set-up to their specifications.

Referring now to FIG. 6, the interface 103 illustrates adding a permission 602 to a list of permissions 601 by adding the text to the prompt 602 and pressing the delete add button 603. Similarly to FIG. 3, to remove a permission, the permission may be highlighted in the list of permissions 601 and removed by clicking the delete button 604.

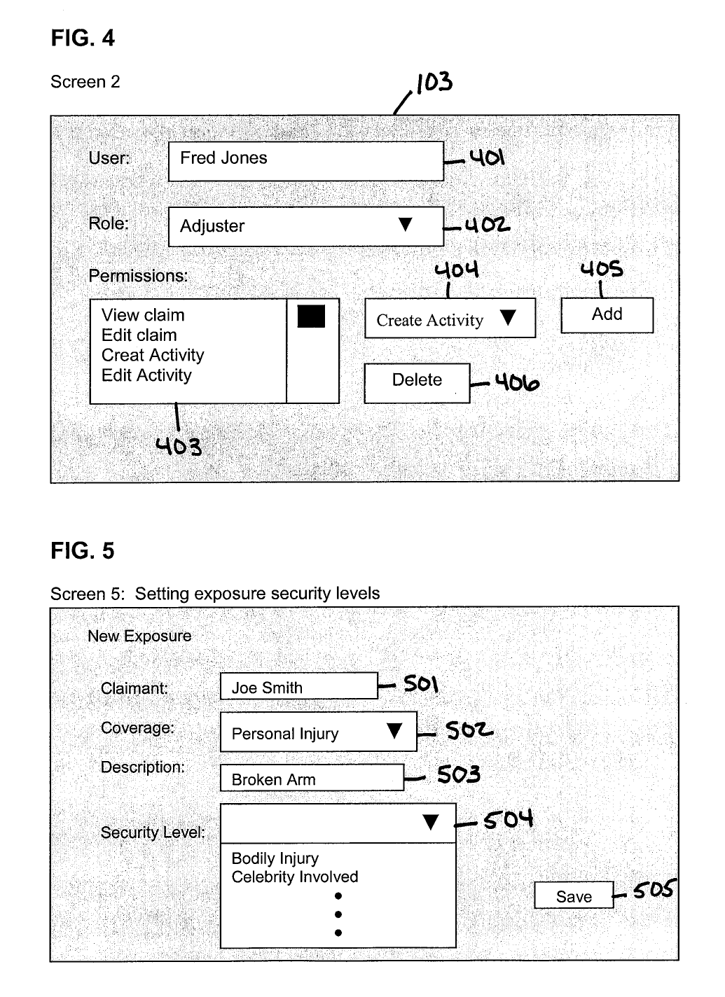

Referring to FIG. 4, the interface 103 shown in the illustrative screen shot prompts an end user to associate or assign permissions to a system user 401. As suggested previously, if desired the system can be configured to list or assign a set of permissions to the list of permissions 403 automatically upon the selection of a particular role or multiple roles. In this embodiment, the user 401 is assigned a role 402 and a number of permissions are predefined for the user 401. If multiple roles are granted to a user, the permissions granted to that user are the sum of the permissions defined by the multiple roles. In this illustration, a user 401 shown, Fred Jones, is given the role of adjuster and has been granted a list of permissions 403 that includes the permission to view claim, edit claim, create activity, and close activity. In this embodiment, if the end user wants to grant the user 401 additional permissions, such permissions can be selected from a list of available permissions 404 and then added 405 to the list of permissions 403. As shown in FIG. 4, the permission “create activity” has been selected from the available permissions in a drop down menu 404 and once the end user selects add 405, the permission will be displayed in the list of permissions 403. If for a particular user 401 the end user wishes to restrict access, the permission from the list of permissions 403 may be highlighted and then deleted 406. By another approach, the end user will not be prompted to insert a role for a particular user but instead may highlight a selection from a list of available permissions for each user.

Considering now FIG. 5, an illustrative screenshot of the user interface 103 depicts prompting an end user to enter liability exposure data in regards to a new exposure. Note that the information requested includes: a claimant name 501, the type of coverage 502, a description 503 of the incident, and the exposure security level listed in a drop down menu 504. The drop down menu illustrated includes the exposure security levels 303 shown in FIG. 3 in addition to the bodily injury level 301 added. In this illustration, a claimant 501 named Joe Smith is covered for personal injury 502, which may include the broken arm listed in the description 503. As the user is inserting data pertaining to the exposure in FIG. 5 the process 200 has prompted the user to manually set the exposure security level. As previously discussed, the exposure security level could be set automatically such that if “personal injury” is listed as the coverage 502, the “bodily injury” exposure security level is associated with the liability exposure data. In FIG. 5, once the end user has selected the security level 504, which would appear to be the “bodily injury” security level, the system can save 505 the exposure security level and liability exposure data, thus associating a declared exposure security level to a new exposure and data therein. While FIG. 5 illustrates a drop-down menu, it is contemplated that a user can select a number of security levels. Thus, if Joe Smith is a celebrity then the exposure security levels selected will likely include the bodily injury security level and the celebrity involved security level. Thus, a user attempting to access the liability exposure data correlating to the celebrity Joe Smith's bodily injury claim must have the permissions required by these two associated security levels.

Turning now to FIG. 7, an illustrative screenshot of the user interface 103 shows how an end user could map the permissions 701, listed in drop down menus, to the exposure security levels 702. Although listed in a drop down menu, it is contemplated that a plurality of permissions 701 will be highlighted and selected for each of the exposure security levels. Further, a particular permission, such as the permission to view, may be selected for all of the exposure security levels.

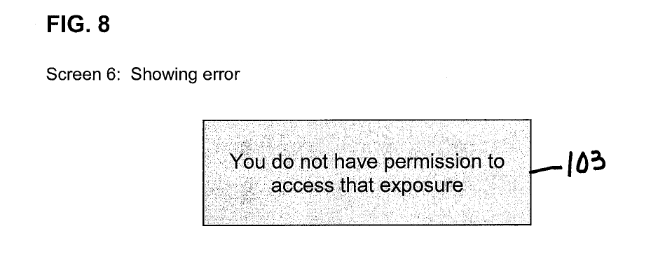

As previously discussed, upon the attempt by a user to access the exposure and exposure liability data, the processor 101 will automatically verify 205 whether the user has been granted the permission to access the exposure security level as corresponds to the exposure liability data. As illustrated in FIG. 8, if the attempt by the user requires a permission that has not been granted to a user for the particular exposure security level of the data sought, then the interface 103 will indicate that “you do not have permission to access that exposure.” Alternatively, if the user does have the particular permissions required, the interface 103 can indicate such access by displaying the exposure liability data the related functions requested.

Those skilled in the art will recognize and understand that such a computer-based processing system may be comprised of a plurality of physically distinct elements as is suggested by the illustration shown in FIG. 1. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, those skilled in the art will recognize and appreciate that these teachings provide an efficient, highly scalable approach to establishing appropriate levels and kinds of protection as pertain to various ways of accessing or otherwise interfacing with information of various kinds as relate to insurance claims and the like. These teachings are sufficiently flexible to permit a given end user to customize the particular approaches employed to suit their own needs and/or opportunities.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for controlling access to liability exposure data in a computer-based processing system, the method comprising:
in the computer-based processing system:
receiving input from an end user declaring a plurality of exposure security levels to provide declared exposure security levels and associating the declared exposure security levels to corresponding particular liability exposure data;
receiving input from the end user declaring at least one permission for a first user;
mapping the at least one permission to at least one of the declared exposure security levels;
upon an attempting user's attempt to access the particular liability exposure data, automatically verifying whether the attempting user has the at least one permission required to access the mapped exposure security level as correlates to the particular liability exposure data.

2. The method of claim 1 wherein if the attempting user has the at least one permission required to access the mapped exposure security level correlating to the particular liability exposure data, granting the attempting user access to the particular liability exposure data.

3. The method of claim 1 wherein if the attempting user lacks the at least one permission required to access the mapped exposure security level correlating to the particular liability data, denying the attempting user access to the particular liability exposure data.

4. A method for use with a computer-based processing system having a user interface, the computer-based processing system for use in managing incident-related work, wherein the incident-related work is associated with a plurality of liability exposures, the method comprising:
in the computer-based processing system:
storing in memory:
a list of exposure security levels declared by an end user wherein at least some of the exposure security levels are associated with at least one corresponding one of the plurality of liability exposures;
a list of permissions declared by an end user, the list of permissions having been associated with at least one user and wherein individual permissions are correlated with exposure security levels;
controlling access to a particular one of the liability exposures by automatically evaluating whether a particular user seeking access has a particular one of the permissions required to access, via the user interface, a particular one of the exposure security levels as is associated with the particular one of the liability exposures.

5. The method of claim 4 wherein one of the permissions comprises a fundamental access right to access the liability exposure correlated with the exposure security level.

6. The method of claim 5 wherein other of the permissions comprise supplemental access rights that correspond to specific types of permissions that may be accorded to the at least one user in addition to the fundamental access right.

7. The method of claim 4 wherein the list of exposure security levels comprises a status comprising at least one of:
public;
sensitive;
extremely-sensitive.

8. The method of claim 4 wherein associating the exposure security levels with the plurality of liability exposure occurs by at least at one of:
manual association;
automatic association.

9. The method of claim 4 wherein a plurality of permissions may be associated with the at least one user.

10. The method of claim 4 wherein the particular one of the exposure security levels corresponds to a particular exposure type.

11. An apparatus to facilitate controlling access to liability exposure data in a computer-based processing system, the apparatus comprising:
a user interface;
a memory operably coupled to the user interface and being configured and arranged to store therein:
input received via the user interface from an end user comprising a plurality of declared exposure security levels;
input received via the user interface from the end user comprising at least one permission for a first user;
a processor operably coupled to the user interface and the memory and being configured and arranged to:
map at least one of the declared exposure security levels to the at least one permission to provide a mapped exposure security level;
associate the mapped exposure security level to particular liability exposure data;
automatically verifying whether an attempting user who is attempting to access the particular liability exposure data has the at least one permission required to access the mapped exposure security level as correlates to the particular liability exposure data.

12. The apparatus of claim 11 wherein the processor is further configured and arranged to grant the attempting user access to the particular liability exposure data when the attempting user has the at least one permission required to access the mapped exposure security level correlating to the particular liability exposure data.

13. The apparatus of claim 11 wherein the processor is further configured and arranged to deny the attempting user access to the particular liability exposure data when the attempting user lacks the at least one permission required to access the mapped exposure security level correlating to the particular liability data.
